(19) United States
(12) Patent Application Publication
(10) Pub. No.: US 2006/0069183 A1
(43) Pub. Date: Mar. 30, 2006

(54) Erasable aqueous color material composition

(75) Inventors: Norimasa Kurihara, Osaka-shi (JP); Kazuhiro Kawauchi, Osaka-shi (JP); Shigeki Yoneda, Osaka-shi (JP)

Correspondence Address: HAMRE, SCHUMANN, MUELLER & LARSON, P.C., P.O. BOX 2902-0902, MINNEAPOLIS, MN, 55402, US

(73) Assignee: SAKURA COLOR PRODUCTS CORPORATION, Osaka-shi (JP)

(21) Appl. No.: 11/235,981

(22) Filed: Sep. 27, 2005

(30) Foreign Application Priority Data
Sep. 30, 2004 (JP) 2004-286413
Sep. 30, 2004 (JP) 2004-286416
Jan. 20, 2005 (JP) 2005-012814
Jan. 20, 2005 (JP) 2005-012822
May 25, 2005 (JP) 2005-152439

(51) Int. Cl. C03C 17/00; C09D 11/00

(52) U.S. Cl. 523/160; 523/161

(57) ABSTRACT

The present invention provides erasable aqueous color material composition for scratching off comprising pigment particles with opacifying property and aqueous emulsions of resins with lump coagulation property, wherein said pigment particles with opacifying property are scaly aluminum particles or synthetic resin particles, and said aqueous emulsions of resins with lump coagulation property are aqueous emulsions of styrene butadiene rubber or carboxy modified styrene butadiene rubber.

### FIELD OF THE INVENTION

The present invention relates to an erasable aqueous color material composition in which written lines (including handwriting films) or coating films formed by printing on, stamping on, writing on, coating on so-called absorbing surfaces such as paper, cloth, and the like are scratched off with coins rubbers, or the like, thereby capable of erasing said written lines (including handwriting films) or coating films. In more detail, the present invention relates to an aqueous composition for scratching off of one pack provided with scratching-off property in which letters and the like on a substrate can be opacified by printing on, stamping on, writing on, or coating on an absorbing surface such as paper, cloth, and the like, and when said opacified coating films are scratched off and erased with coins and the like, said letters and the like on said substrate can be made out. In addition, the present invention relates to an erasable aqueous ink in which written lines (including handwritten films) formed by writing on or coating on a so-called absorbing surface such as paper, cloth, and the like are scratched off, for example, with a rubber, said written lines can be erased.

### BACKGROUND OF THE INVENTION

As conventional erasable color material compositions, in particular, as ink compositions forming a printing surface with scratching-off property, ink compositions for scratching off which include such as aluminum powders, styrene butadiene rubber, acrylonitrile butadiene rubber, and organic solvents toluene, xylene, methylisobutylketone, and the like have been provided (Japan unexamined patent publication No. 2003-145967).

In addition, aqueous ink compositions for scratching-off compounded with aluminum paste, water, and aqueous polyurethane acryl emulsion have also been provided (Japan unexamined patent publication No. 2003-191672).

However, since Japan unexamined patent publication No. 2003-145967 discloses an invention of a composition which includes organic solvents, it is not an aqueous ink composition. From the viewpoint of safety and handling, the composition is desirably an aqueous ink composition. Further, since it is required that the ink compositions disclosed in Japan unexamined patent publication Nos. 2003-145967 and 2003-191672 should be coated on release layer formed, undercoating is essential, making direct printing on plain paper impossible.

In addition, as conventional erasable ink compositions, in particular, erasable aqueous ink compositions using styrene butadiene copolymers or acrylonitrile butadiene copolymers as film forming resins are provided (Japan unexamined patent publication No. 2003-055593). However, such conventional erasable aqueous ink compositions have problems in that written lines are easily peeled off not only with rubber erasers but also with fingers.

The object of the present invention is to provide an erasable aqueous color material composition capable of easily erasing written lines or coating films with coins, rubbers, and the like without damaging paper. In more detail, the object of the present invention is to provide an erasable aqueous color material composition providing aqueous compositions for scratching off capable of scratching off with coins and the like or erasable aqueous ink compositions erasable with rubbers. In addition, the object of the present invention is to provide an erasable aqueous color material composition capable of direct printing, stamping, writing, or coating on plain paper requiring no undercoating when applied for aqueous compositions for scratching off. Further, the object of the present invention is to provide erasable aqueous ink compositions capable of forming written lines (coating films) which are non-erasable when rubbed with fingers and can be erased at the time of erasing without damaging paper when applied for erasable aqueous ink compositions.

### SUMMARY OF THE INVENTION

The present invention relates to erasable aqueous color material compositions comprising colorants and aqueous emulsions of resins with lump coagulation property. When the present compositions are applied for aqueous compositions for scratching off, as said colorants, pigment particles having opacifying property are preferably contained. In other words, the present invention relates to erasable aqueous color material compositions comprising pigment particles with opacifying property and aqueous emulsions of resins with lump coagulation property. In addition, when the present invention is applied for aqueous rubber erasable ink compositions, the erasable aqueous color material compositions preferably comprise colorants and film forming resins, wherein as said film forming resins, aqueous emulsions of resins with lump coagulation property and aqueous emulsions of acryl series resins.

Here, resins having lump coagulation property indicate such resins with characteristics of forming coating films which are brittle and which turn outward since resin particles in an emulsion are coagulated in the process that coating films which were coated on paper dry. Since compositions themselves comprising said resin are provided with lump coagulation property, when they are coated on coated bodies (such as paper surfaces and the like) and when the coating films are scratched-off with hard materials such as coins and the like, coating films themselves which are bonded are more severely destroyed than said coated bodies (such as paper surfaces and the like), and therefore, coating films are destroyed, while preventing said coated bodies (such as paper surfaces and the like) from being destroyed. Therefore, lump coagulation property mentioned in the present invention is considered to have properties such as interfacial failure, cohesive failure, mixed failure, and the like which does not or hard to destroy coated bodies (such as paper surfaces and the like).

As said resins which provide said compositions with lump coagulation property, specific examples include rubber latex which are aqueous emulsions of styrene butadiene rubber, acrylonitrile butadiene rubber, carboxy modified styrene butadiene rubber, or the like.

In addition, regarding drying temperature, in the case of normal temperature desiccation, it is preferable that aqueous resin emulsions which have a glass transition point (Tg) with upper limit value of not greater than −30° C., preferably not greater than −40° C., and further preferably not greater than −50° C. and with lower limit value of preferably −100° C. and further preferably −70° C. are contained in such compositions. To be specific, it is preferable that aqueous emulsions of styrene butadiene rubber (SBR) series with a glass transition point (Tg) of not greater than −30° C. such as styrene butadiene rubbers, carboxy modified styrene butadiene rubber, and the like, or aqueous resin emulsions of acrylonitrile butadiene rubbers (NBR) are included in said compositions.

Further, for example, aqueous emulsions (latexes) of resins having minimum film forming temperature (MFT) or glass transition point (Tg) higher than drying temperature of coating films to be formed can be used. To be specific, it is preferable that aqueous emulsions with a minimum film forming temperature (MFT) or a glass transition point (Tg) higher than drying temperature of coating films to be formed including emulsions of styrene butadiene rubber (SBR) series such as styrene butadiene rubber or carboxy modified styrene butadiene rubber or aqueous resin emulsions such as acrylo nitrilebutadiene rubber (NBR) are included in said compositions.

For example, regarding drying temperature, in the case of normal temperature desiccation, it is preferable that aqueous emulsions of resins which have a glass transition point (Tg) with lower limit value of not less than 30° C., preferably not less than 35° C., and further preferably not less than 40° C. and with upper limit value of not greater than 80° C., and preferably not greater than 70° C., and further preferably, not greater than 60° C. are contained in said compositions. To be specific, it is preferable that aqueous resin emulsions of styrene butadiene rubber (SBR) series with a glass transition point (Tg) of not less than 30° C. such as styrene butadiene rubber or carboxy modified styrene butadiene rubber, or aqueous resin emulsions of acrylonitrile butadiene rubber (NBR) are included in said compositions.

As mentioned above, since aqueous resin emulsions of resins with a glass transition point (Tg) of not greater than −30° C. have lump coagulation property, and since aqueous resin emulsions of resins with a glass transition point (Tg) of not less than 30° C. form aggregates without forming films, by regulating the mixture of aqueous resin emulsions of resins with a glass transition point (Tg) of not greater than −30° C. and aqueous resin emulsions of resins with a glass transition point (Tg) of not less than 30° C., peel-off property (peel-off strength or adhesion strength) of dried coating films depending on kinds of papers can be controlled.

In addition, as pigment particles which have opacifying property, aluminum particles or synthetic resin particles (resin spheres) can be exemplified and by adding particles with opacifying property such as aluminum pastes and the like, for example, preferable compositions for scratching off can be obtained.

### DETAILED DESCRIPTION OF THE EMBODIMENTS

As mentioned above, the present invention is composed of erasable aqueous color material compositions which comprise colorants and aqueous emulsions of resins with lump coagulation property. And when the present composition is applied for aqueous compositions for scratching off, erasable aqueous color material compositions comprising pigment particles with opacifying property and aqueous emulsion of resins with lump coagulation property, and when the present composition is applied for aqueous rubber erasable ink compositions, erasable aqueous color material compositions comprising colorants and film forming resins are preferable, wherein as said film forming resins, aqueous emulsions of resins with lump coagulation property and aqueous emulsions of acryl series resins.

Since in the compositions of the present invention, emulsions do not penetrate into absorbing surfaces such as paper, and the like, coating films have appropriate adhesion and do not fall off even when rubbed by inner surfaces of fingers. Further, since coating films are brittle, when they are rubbed with hard materials such as coins, rubbers such as synthetic rubbers, and the like, without damaging paper, coating films can be peeled off. And when the present compositions are applied for aqueous compositions for scratching off, letters written on substrates after peel-off can be made out. Further, the compositions of the present invention require no undercoating and direct printing on plain paper is available. By further adding wetting agents or permeating thickening agents such as thixotropic thickening agents thereto, stamp inks can be prepared capable of directly stamping on and stenciling on plain paper.

In addition, the compositions of the present invention can form written lines (coating films) that are not erasable by rubbing with fingers or rubber erasers by controlling strength of coating films by adding acryl emulsions to emulsions of resins such as SBR with lump coagulation property. On the other hand, by using rubbers such as natural rubbers or synthetic rubbers as erasing means, utilizing high friction forces among rubbers which compose written lines, only written lines can be erased by applying erasing forces thereto. In addition, in the ink compositions of the present invention, since maximum adhesion is imparted on written lines within the range of not breaking paper, by controlling the strength of coating films, adding acryl emulsions to resin emulsions with lump coagulation property of SBR and the like, friction between papers can be prevented, and therefore, at the time of erasing, erasing is available without damaging paper.

(Colorants)

Colorants can be used in the present invention. As colorants used in the present invention, for example, in addition to water-soluble dyes such as acid dyes, direct dyes, basic dyes, and the like, inorganic pigments such as carbon black, titanium dioxide, silicate alumina, talc, and the like, organic pigments such as azo pigments, naphtol pigments, phthalocyanine pigments, threne pigments, quinacridone pigments, anthraquinone pigments, dioxane pigments, dioxadine pigments, indigo pigments, thioindigo pigments, perynon pigments, perylene pigments, indolenone pigments, azomethine pigment, and the like, metallic powder pigments such as aluminum powders, bronze powders and the like, fluorescent pigments, pearlescent pigments, glittering pigments, and the like are exemplified. In addition, these can be used as pigment dispersions. Further, these colorants can be used alone or in combinations of two or more of them. Moreover, plastic pigments (synthetic resin particle/resin spheres) with various shapes such as spherical, flattened, hollow, fine particle lump-like, and the like can be used. For example, in the present invention, resin powders can be used with a diameter of not greater than 100 μm or in the form of water-dispersed state with a diameter of not greater than 100 μm. Said resin powders can be used as colored resin emulsions colored by pigments or dyes.

Colorants used in the present invention are preferably contained in 0.1 to 20% by weight with respect to the total amount of the aqueous ink compositions, particularly in 0.1 to 10% by weight. When colorants are included more than 20% by weight, stability with time passage as an ink deteriorates. When colorants are included less than 0.1% by weight, color gets light and coloring property deteriorates.

As said glittering pigments, for example, metal coated glass flake pigments, metal coated inorganic pigments, metal oxide coated inorganic pigments, pearlescent pigments, aluminum pigments, metal foil, metal-deposited films, metal deposition films (metallized film obtained by, for example, peeling off metal deposition layers which are deposited on films), and the like are exemplified. Here, metal coated glass flake pigments are defined as pigments composed of the structure in which flaky glasses are coated with metals (alloys). In addition, metal coated inorganic pigments are defined as a generic term of inorganic pigments coated with metals (alloys). Inorganic pigments coated with metal oxide (for example, metallic pigments such as aluminum pigments and the like with metal oxide coated) can also be used.

In addition, in the composition of the present invention, colorants may be included or excluded and as required, they can be added.

In addition, when the composition of the present invention is used as compositions for scratching off, it is preferable to use pigment particles with opacifying property, or it is further preferable to use scaly particles. For example, pigment particles with opacifying property such as aluminum pigments, plastic pigments (synthetic resin particle pigments), inorganic pigments such as talc, alumina, and the like can be used alone or in combinations of two or more of them.

As aluminum pigments, in particular, as scaly aluminum particles, aqueous aluminum paste can preferably be used. For example, trade names “WXM1440” (median diameter 30 μm), “WXM1415” (median diameter 51 μm), “WXM7943” (median diameter 60 μm), “WXM0620” (median diameter 20 μm), “WXM0650” (median diameter 5 μm), manufactured by Toyo Aluminium K.K. are exemplified. In particular, trade name “WXM1440” (median diameter 30 μm) is preferable. In addition, a “median diameter” indicates the value of D₅₀ (μm) measured by a laser diffraction method.

In aqueous color material compositions of the present invention, as said plastic pigments (synthetic resin particles/resin spheres), resin particles composed of synthetic resins including olefin series resins such as polyethylene, polypropylene, and the like, vinyl series resins such as polyvinyl chloride, and the like, styrene series resins such as polystyrene and the like, acryl series resins such as polymethacrylate ester, (for example, polymethylmethacrylate, and the like), polyacrylate ester, and the like, and nylon series resins, fluorine series resins, amine series resins, and the like. Among them, those composed of styrene series resins can preferably be used. Resin spheres can be used alone or in combinations of two or more of them.

It is preferable that an average particle diameter of said resin particles is not greater than 10 μm for good ink flowage. To be more specific, an average particle diameter of flat resin particles is about 0.05 to 10 μm, preferably about 0.1 to 5 μm, and further preferably about 0.2 to 1 μm. In addition, thickness of resin particles is preferably about one third or two thirds of said average particle diameter. In addition, the average particle diameter of flat resin particles is represented by the average value of a diameter excluding thickness.

In addition, in the aqueous color material composition of the present invention, “spherical particles” mean particles whose shapes are spherical or substantially spherical, and “flat particles” mean particles whose shapes are flat. Therefore, “flat particles” include particles whose shapes are flat with spherical particles flattened out. In other words, as flat resin particles, flat bodies can be illustrated which are composed of said synthetic resins and have substantially circular disc shapes (for example, oval or round-shaped discs, and the like). In addition, at the central portion of the surface in these solid-core flat bodies, piercing pores may be provided (in other words, so-called doughnut-shapes) and at least the central portion of one surface may be fallen in. Here, the size of said piercing pores or concave portions (fallen-in portions) is not specifically limited.

As said resin particles, they may be used in particulate forms, in dispersions by water and/or water-soluble organic solvents, or in emulsions. In preparing emulsions, commonly used surfactants can be used. In addition, concentration of resin particles in emulsions is not specifically limited and in many cases, the content is 30 to 50% by weight with respect to the total amount of the emulsion. Of course, in dispersions by water and/or water-soluble organic solvents, concentration of flat resin particles is not limited.

As spherical (dense) particles, for example, trade names LX407BP (average particle diameter: 0.40 μm), LX407BP6 (average particle diameter: 0.20 μm) manufactured by ZEON CORPORATION and trade name MR2G (average particle diameter: 1.00 μm) manufactured by Soken Chemical & Engineering Co., Ltd. can be used, and as hollow particles, for example, trade names ROPAQUE HP-1055 (average particle diameter: 1.00 μm), ROPAQUE HP-91 (average particle diameter: 1.00 μm), ROPAQUE OP-84J (average particle diameter: 0.55 μm), ROPAQUE HP433J (average particle diameter: 0.40 μm) manufactured by ROHM AND HASS COMPANY, trade name MH5055 (average particle diameter: 0.50 μm) manufactured by ZEON CORPORATION, trade names SX866(A) (average particle diameter: 0.30 μm), SX866(B) (average particle diameter: 0.30 μm), SX866(C) (average particle diameter: 0.30 μm), SX866(D) (average particle diameter: 0.30 μm), SX8782 (D) (average particle diameter: 1.00 μm), SX8782(A) (average particle diameter: 1.10 μm), and SX8782(P) (average particle diameter: 1.00 μm) manufactured by JSR K.K. can be used.

As particles of fine particle aggregations, MUTICLE 110 C (average particle diameter: 1.00 μm) manufactured by MITSUI TOATSU CO., LTD. can be used.

As flat resin particles, for example, trade name MUTICLE PP240D manufactured by MITSUI TOATSU CO., LTD. (average particle diameter: 0.5 μm), and the like can be used.

The above synthetic resin particle pigments are preferably used. Among them, synthetic resin particle pigments (resin spheres) of hollow particles and/or flat particles are preferably used. As opacifying agents, in the case that said synthetic resin particle pigments are used, when colored pigments and/or dyes and synthetic resin particle pigments are included as opacifying agents, varieties of colors can be imparted depending on colors as well as to impart opacity to an ink. In addition, unlike when aluminum is used as opacifying agents, settlement in the ink is prevented and therefore, preservation stability of the ink is preferable.

When the compositions of the present invention are used as compositions for scratching off, the content of said pigment particles is preferably 1 to 60% by weight with respect to the total amount of the present composition, and further preferably, 5 to 35% by weight. Here, when opacifying pigment particles are pigment dispersions such as aluminum pastes and the like, solid contents correspond to contents. When the content of said opacifying pigment particles is less than 1% by weight with respect to the total amount of the ink composition, opacifying property decreases, while on the other hand, when the content exceeds 60% by weight, stability with time passage degrades and when filled in stamping sponges, filling capacity deteriorates.

When the compositions of the present invention are used as rubber-erasable aqueous compositions (aqueous ink compositions), the content of resins to be used is about 0.1 to 30% by weight with respect to the total amount of said compositions and preferably, about 1 to 25% by weight. When the content of resin particles to be used is too small, coloring property is weak, while on the other hand, when the content of resin particles to be used is too large, solid contents become too much and writing property deteriorates.

(Resins Having Lump Coagulation Property)

Resins with lump coagulation property used in the present invention can be used as aqueous emulsions (O/W emulsions). As resins, for example, SBR emulsions of styrene butadiene rubber (SBR), acrylonitrile butadiene rubber (NBR), carboxy modified styrene butadiene rubber, and the like can be used and they can be contained in the state of aqueous emulsions in a composition for scratching off, respectively. To be specific, trade names “0561” (solid content: 69% by weight, Tg: −63° C.), “2853” (solid content: 50% by weight, Tg: −51° C.), “0602” (solid content: 52% by weight, Tg: 40° C.), “0640” (solid content: 48% by weight, Tg: 55° C.) manufactured by JSR K.K. can be used.

In addition, as mentioned above, since aqueous emulsions of resins with a glass transition point (Tg) of not greater than −30° C. form films with lump coagulation property, while aqueous emulsions of resins with a glass transition point (Tg) of not less than 30° C. do not form films but form brittle lump coagulation body, by controlling mixture of aqueous SBR emulsions of styrene butadiene rubber (SBR), acrylonitrile butadiene rubber (NBR), carboxy modified styrene butadiene rubber, and the like with a glass transition point (Tg) of not greater than −30° C. and aqueous SBR emulsions of styrene butadiene rubber (SBR), acrylonitrile butadiene rubber (NBR), carboxy modified styrene butadiene rubber, and the like with a glass transition point (Tg) of not less than 30° C., peel-off property (peel-off strength or adhesion strength) of dried coating films depending on paper can be controlled.

Although mixture ratio of resin A with a glass transition point (Tg) of not greater than −30° C. and resin B with a glass transition point (Tg) of not less than 30° C. can be adjusted depending on paper for adhesion, for example, it is preferable that peel-off strength is adjusted to be small for ordinary paper and that peel-off strength is adjusted to be large for coated paper. To be specific, the mixture ratio of [resin B/resin A] is within 0.1 to 10, and preferably 0.45 to 9.4.

This resin is contained in 5 to 50% by weight in solids (resin content) with respect to the total amount of the present color material composition, and preferably contained in 10 to 30% by weight in solids (resin content). When this resin is contained in more than 50% by weight in solids (resin content) with respect to the total amount of the aqueous ink composition, adhesion property of coating film weakens and written lines (coating films) easily fall off when rubbed with fingers. On the other hand, when this resin is contained in less than 5% by weight in solids (resin content), coating films satisfactory for erasing are hard to get.

In addition, when the color material compositions of the present invention are applied for aqueous compositions for scratching off including pigment particles with opacifying property, the color material compositions are contained in 5 to 40% by weight in solids (resin content) with respect to the total amount of the aqueous compositions for scratching off, and preferably contained in 10 to 20% by weight in solids (resin content). When this resin is contained in more than 40% by weight in solids (resin content) with respect to the total amount of the aqueous compositions for scratching off, stability with passage of time deteriorates and when this resin is contained in less than 5% by weight in solids (resin content), adhesion property and lump coagulation property lower.

(Acryl Series Resins)

When the present color material compositions are applied for rubber erasable aqueous ink compositions, it is preferable that such compositions comprise colorants and film forming resins and that said film forming resins include aqueous emulsions of resins with powder-coagulation property and further aqueous emulsions of acryl series resins.

As acryl series resins, for example, acrylic resins, styrene acrylic resins, acrylic acid ester copolymer, and the like are exemplified. But among them, acrylic resins are preferable. Acryl series resins are contained in 5 to 50% by weight in solids with respect to the total amount of the present compositions, and preferably contained in 10 to 30% by weight in solids. When acrylic resins are contained in more than 50% by weight in solids, adhesion property of written lines (coating films) increases and get hard to erase. On the other hand, when acrylic resins are contained in less than 5% by weight in solids, adhesion property decreases and sometimes written lines (coating films) are erased by fingers.

In addition, although the ratio of the content in solids of aqueous emulsions of resins with powder-coagulation property such as said styrene butadiene rubber, carboxy modified styrene butadiene rubber, acrylonitrile butadiene rubber and the like and said aqueous emulsions of said acryl series resins can appropriately be determined considering the balance of erasability securing and adhesion property of coating films, it is preferable that the content amount of said aqueous emulsions of resins with powder-coagulation property and said aqueous emulsions of acryl series resins is almost the same, respectively. In particular, it is most preferable that the above content amount is almost the same, respectively within the range of preferable content amount of said resins with powder-coagulation property and acryl series resins. When styrene butadiene rubbers and the like are contained more, adhesion property decreases, while on the other hand, when acryl series resins are contained more and styrene butadiene rubbers and the like are contained less, adhesion property increases and get hard to be peeled off.

(Wetting Agents)

Wetting agents can be used in the compositions of the present invention. In particular, it is desirable to use wetting agents when the present compositions are used as stamp inks and in particular, as compositions for scratching off. Examples for wetting agents include glycerin, diglycerin, propylene glycol, ethylene glycol, sorbitol, and the like. Among them, glycerin and sorbitol are preferable. Wetting agents are preferably contained in not greater than 60% by weight, further preferably contained in 10 to 40% by weight. When wetting agents are contained in more than 60% by weight with respect to the compositions of the present invention, said compositions gets hard to dry. On the other hand, when wetting agents are contained in less than 10% by weight with respect to the compositions of the present invention, cap-off performance deteriorates.

(Thickening Agents)

In the compositions for scratching off of the present invention, although thickening agents are not necessarily used, however, they may be used. In particular, it is preferable to use thickening agents in order to prevent said opacifying scaly particles (pigment particles) from settling out. As thickening agents, water-soluble thickening agents are preferable and in particular, thixotropic imparters are further preferable. Microbial polysaccharides and derivatives thereof are preferable and pullulan, xanthane gum, wellan gum, rhamsan gum, succinoglucan, and dextran can be exemplified. In addition, water-soluble plant polysaccharides and the derivatives thereof are preferable and tragacanth gum, guar gum, tara gum, locust beangum, gumarabic, pectin, starch, carageenan, agar, alginic acid can be exemplified. Further, water-soluble animal polysaccharides and the derivatives thereof are preferable and gelatin and casein can be exemplified. Rhamsan gum, wellan gum, xanthane gum, and succinoglucan which are used as thixotropy imparters can more preferably be used.

In particular, when a stamp ink is prepared, it is preferable to use thixotropy imparters. For example, polyglycerol mono-fatty acid ester and sorbitan mono-fatty acid ester can be exemplified and particularly, polyglycerol mono-fatty acid ester is preferably used. The content is not greater than 60% by weight and preferably, 10 to 40% by weight. When the content exceeds 60% by weight, the composition for scratching off is hard to dry. On the other hand, when the content is less than 10% by weight, opacifying scaly particles, in particular, aluminum particles are liable to settle out.

(Water)

Water is used in the compositions for scratching off of the present invention in order to prepare aqueous compositions for scratching off. As water, for example, ion-exchange water can be used. To be specific, water can be contained in 0.1 to 90% by weight, and depending on each component to be compounded, it can be adjusted as remnants.

(Other Components)

In the compositions for scratching off of the present invention, as for other components, water-soluble organic solvents, surfactants, antiseptic mildew-proofing agents, rust inhibitors, anti foaming agents, perfumes, antioxidants, light stabilizers, and the like can be contained.

(Erasing Means)

Written lines or coating films formed on a surface of paper and the like using aqueous color material compositions of the present invention can be erased with coins, natural rubbers, or synthetic rubbers.

In particular, erasable aqueous color material compositions which include pigment particles with opacifying property and aqueous emulsions of resins with lump coagulation property can be used as compositions for scratching off. Therefore, a using method of erasable aqueous color material compositions can be employed in which said compositions for scratching off are printed on, stamped on, written on, or coated on an absorbing surface of paper and the like, thereby opacifying letters and the like written on a substrate, said opacified coating films are erased by scratching off with coins and the like, thereby making out the letters written on a substrate. In addition, when erasable aqueous color material compositions comprising colorants and film forming resins, wherein as said film forming resins, aqueous emulsions of resins with lump coagulation property and aqueous emulsions of acryl series resins are contained are used, such using methods of erasable aqueous color material compositions can be employed in which said compositions are printed on, stamped on, written on, or coated on an absorbing surface of paper and the like to form written lines or coating films, and then, said written lines are erased not by rubbing with rubber erasers but by rubbing with synthetic rubbers.

However, the erasing means of the color material compositions of the present invention are not limited to this. In particular, in the case of erasable aqueous color material compositions comprising colorants and film forming resins, wherein as said film forming resins, aqueous emulsions of resins with lump coagulation property and aqueous emulsions of acryl series resins are contained, when erasable means composed of materials not including polishing particles, provided with flexibility to fit to a written surface, having shape retaining property larger than adhesion of coating films of written lines are employed, only written lines (coating films) can be peeled off easily without any damage to a written surface.

For example, it is preferable to employ thermoplastic resins, thermosetting resins, thermoplastic elastomers, vulcanized rubbers, sintered bodies of inorganic substances for obtaining the above mentioned characteristics, and it is further preferable that the above materials are any one of vinyl chloride series resins, acryl series resins, styrene series thermoplastic elastomers, and natural and synthetic vulcanized rubbers. Further, when said erasing means are provided with one or more corners in outer shapes, erasing capacity increases greatly for written lines formed by said inks. In addition, when the hardness shown by a C-type hardness meter is 70 to 98 in said erasing means, coherent property to a paper surface is good and therefore, written lines can be erased with smaller number of rubbing.

### EXAMPLES

Using publicly known methods of producing inks, aqueous color material compositions for scratching off as desired were obtained. To be specific, all the materials stated in Table 1 or 2 were put and were stirred with a dissolver for 30 minutes, thereby obtaining compositions for scratching off in the Examples and Comparative Examples.

TABLE 1
(% by weight)

| | | | | Particle | | | | | | | |
|---|---|---|---|---|---|---|---|---|---|---|---|
| | | | | diameter | Examples | | | | | | |
| | | | Trade name | (μm) | 1 | 2 | 3 | 4 | 5 | 6 | 7 |
| Ink | Particles | Aluminum | WXM1415 | | 10.0 | | 10.0 | 10.0 | | 10.0 | |
| composition | with | particles | WXM1440 | | | 15.0 | | | 15.0 | | 10.0 |
| | opacifying | Resin | ROPAQUE | 0.3 | | | | | | | |
| | property | particles | ULTRA | | | | | | | | |
| | | | (wt % in solids) | | | | | | | | |
| | | | MUTICLE 240D | 0.5 | | | | | | | |
| | | | (wt % in solids) | | | | | | | | |

| | | | | | | | | | | |
|---|---|---|---|---|---|---|---|---|---|---|
| | Aqueous resin emulsion | 0561 (wt % in | | 60.0 | | 30.0 | 50.0 | | 30.0 | |
| | | solids) | | (42.0) | | (21.0) | (35.0) | | (21.0) | |
| | | 2853 (wt % in | | | 60.0 | | | 50.0 | | 30.0 |
| | | solids) | | | (30.0) | | | (25.0) | | (25.0) |
| | | MOVINYL 700 | | | | | | | | |
| | | (wt % in solids) | | | | | | | | |
| | | UCOATUWS145 | | | | | | | | |
| | | (wt % in solids) | | | | | | | | |
| | | POLYZOL | | | | | | | | |
| | | AP-3700 | | | | | | | | |
| | | (wt % in solids) | | | | | | | | |
| | Glycerin | | | | | | 20.0 | 20.0 | | 20.0 |
| | Polyglycerol mono-fatty | | | | | | 10.0 | 10.0 | 10.0 | 10.0 |
| | acid ester | | | | | | | | | |
| | Sorbitol | | | | | | | | 20.0 | |
| | Ion exchange water | | remnant | remnant | remnant | remnant | remnant | remnant | remnant | remnant |
| | Total (wt %) | | 100 | 100 | 100 | 100 | 100 | 100 | 100 | 100 |
| Evaluation | Opacifying property of | | ◯ | ◯ | ◯ | ◯ | ◯ | ◯ | ◯ | ◯ |
| | substrate | | | | | | | | | |
| | Adhesive property when | | ◯ | ◯ | ◯ | ◯ | ◯ | ◯ | ◯ | ◯ |
| | rubbed with fingers | | | | | | | | | |
| | Adhesive property when | | ◯ | ◯ | ◯ | ◯ | ◯ | ◯ | ◯ | ◯ |
| | rubbed with coins | | | | | | | | | |
| | Making out of letters | | ◯ | ◯ | ◯ | ◯ | ◯ | ◯ | ◯ | ◯ |
| | after peeled off by | | | | | | | | | |
| | rubbing | | | | | | | | | |

| | |
|---|---|
| Examples | Comparative Examples |

| | | | Trade name | 8 | 9 | 1 | 2 | 3 | 4 | 5 |
|---|---|---|---|---|---|---|---|---|---|---|
| Ink | Particles | Aluminum | WXM1415 | | | 10.0 | | 10.0 | | |
| composition | with | particles | WXM1440 | | | | 10.0 | | 10.0 | 10.0 |
| | opacifying | Resin | ROPAQUE | 65.0 | | | | | | |
| | property | particles | ULTRA | (19.5) | | | | | | |
| | | | (wt % in solids) | | | | | | | |
| | | | MUTICLE 240D | | 55.0 | | | | | |
| | | | (wt % in solids) | | (27.5) | | | | | |

| | | | | | | | | | |
|---|---|---|---|---|---|---|---|---|---|
| | Aqueous resin emulsion | 0561 (wt % in | 30.0 | | | | | | |
| | | solids) | (21.0) | | | | | | |
| | | 2853 (wt % in | | 30.0 | | | | | |
| | | solids) | | (25.0) | | | | | |
| | | MOVINYL 700 | | | 60.0 | | 50.0 | | |
| | | (wt % in solids) | | | (30.0) | | (25.0) | | |
| | | UCOATUWS145 | | | | 60.0 | | 50.0 | |
| | | (wt % in solids) | | | | (30.0) | | (18.0) | |
| | | POLYZOL | | | | | | | 50.0 |
| | | AP-3700 | | | | | | | (25.0) |
| | | (wt % in solids) | | | | | | | |
| | Glycerin | | 5.0 | 5.0 | | | 20.0 | 20.0 | 20.0 |
| | Polyglycerol mono-fatty | | | | | | 10.0 | 10.0 | 10.0 |
| | acid ester | | | | | | | | |
| | Sorbitol | | | | | | | | |
| | Ion exchange water | | remnant | remnant | remnant | remnant | remnant | remnant | remnant |
| | Total (wt %) | | 100 | 100 | 100 | 100 | 100 | 100 | 100 |
| Evaluation | Opacifying property of | | ◯ | ◯ | ◯ | ◯ | ◯ | ◯ | ◯ |
| | substrate | | | | | | | | |
| | Adhesive property when | | ◯ | ◯ | ◯ | ◯ | ◯ | ◯ | ◯ |
| | rubbed with fingers | | | | | | | | |
| | Adhesive property when | | ◯ | ◯ | X | X | X | X | X |
| | rubbed with coins | | | | | | | | |
| | Making out of letters | | ◯ | ◯ | X | X | X | X | X |
| | after peeled off by | | | | | | | | |
| | rubbing | | | | | | | | |

N.B.) In the Table, numerical values in parenthesis in the aqueous resin emulsion section show the weight percentage in solids (resin content).

[Notes]

Scaly particles; aqueous aluminum paste, trade name “WXM 1415”, manufactured by Toyo Aluminium K.K., particle diameter of 51 μm

Scaly particles; aqueous aluminum paste, trade name “WXM 1440”, manufactured by Toyo Aluminium K.K., particle diameter of 30 μm

Aqueous resin emulsion; SBR emulsion, trade name “0561”, Tg of −63° C., manufactured by JSR K.K., solid content of 69%

Aqueous resin emulsion; SBR emulsion, trade name “2853”, Tg of −51° C., manufactured by JSR K.K., solid content of 50%

Aqueous resin emulsion; acrylic emulsion, trade name “Movinyl 700”, manufactured by CLARIANT POLYMER K.K., solid content of 50%

Aqueous resin emulsion; urethane emulsion, trade name “U COATUWS145”, manufactured by Sanyo Chemical Industries., Ltd., solid content of 35%

Aqueous resin emulsion; acrylic emulsion, trade name “POLYZOLAP-3700”, manufactured by SHOWAHIGHPOLYMERCO., LTD., solid content of 50%

Hollow resin particles: acryl series resin emulsion (solid content: 30%, average particle diameter: 0.3 μm, manufactured by ROHM AND HASS COMPANY, trade name “ROPAQUE ULTRA”)

Flat resin particles: acryl series resin emulsion (solid content: 50%, average particle diameter: 0.5 μm, manufactured by MITSUI TOATSU CO., LTD., trade name “MUTICLE PP 240D”)

TABLE 2
(% by weight)

| | | | | | | | | | Comparative | | |
|---|---|---|---|---|---|---|---|---|---|---|---|
| | | | | Glass tran- | Examples | | | | Examples | | |
| | | | Trade name | sition point | 10 | 11 | 12 | 13 | 6 | 7 | 8 |
| Ink | Particles | Aluminum | WXM 1440 | | 10.0 | 10.0 | 10.0 | 10.0 | 10.0 | 10.0 | 10.0 |
| compo- | with | particle | | | | | | | | | |
| sition | opacifying | | | | | | | | | | |
| | property | | | | | | | | | | |

| | | | | | | | | | |
|---|---|---|---|---|---|---|---|---|---|
| Aqueous resin | 0561 (wt % | −63° C. | | | | | | | |
| emulsions | in solids) | | | | | | | | |
| | 2853 (wt % | −51° C. | 35.0 | 25.0 | 15.0 | 5.0 | | 10.0 | |
| | in solids) | | (17.5) | (12.5) | (7.5) | (2.5) | | (5.0) | |
| | 0602 (wt % | 40° C. | 15.0 | 25.0 | 35.0 | 45.0 | | | 40.0 |
| | in solids) | | (7.8) | (13.0) | (18.2) | (23.4) | | | (20.0) |
| | 0589 (wt % | 0° C. | | | | | 50.0 | 50.0 | 50.0 |
| | in solids) | | | | | | (25.0) | (25.0) | (25.0) |

| | Glycerin | | 20.0 | 20.0 | 20.0 | 20.0 | 20.0 | 20.0 | 20.0 |
|---|---|---|---|---|---|---|---|---|---|
| | Polyglycerol mono-fatty acid ester | | 10.0 | 10.0 | 10.0 | 10.0 | 10.0 | 10.0 | 10.0 |
| | Ion exchange water | | Remnants | Remnants | Remnants | Remnants | Remnants | Remnants | Remnants |
| | Total (wt %) | | 100 | 100 | 100 | 100 | 100 | 100 | 100 |
| Evalu- | Opacifying property of | Postcard paper | ◯ | ◯ | ◯ | ◯ | ◯ | ◯ | ◯ |
| ation | substrates | Plain paper | ◯ | ◯ | ◯ | ◯ | ◯ | ◯ | ◯ |
| | Adhesion property when | Postcard paper | ◯ | ◯ | ◯ | ◯ | ◯ | ◯ | ◯ |
| | rubbed with fingers | Plain paper | ◯ | ◯ | ◯ | ◯ | ◯ | ◯ | ◯ |
| | Adhesion property when | Postcard paper | ◯ | ◯ | ◯ | ◯ | X | X | ◯ |
| | rubbed with coins | Plain paper | ◯ | ◯ | ◯ | ◯ | X | X | X |
| | Hardness of coated | Postcard paper | 7 | 8 | 9 | 10 | 8 | 8 | 9 |
| | films ^{N.B.2)} | Plain paper | 7 | 8 | 9 | 10 | 8 | 8 | 9 |
| | Making out of letters after | Postcard paper | ◯ | ◯ | ◯ | ◯ | X | X | X |
| | peeled off by rubbing | Plain paper | ◯ | ◯ | ◯ | ◯ | X | X | X |

N.B.1) In the Table, numerical values in parenthesis in the aqueous resin emulsion section show the weight percentage in solids (resin content).
^{N.B.2)} Hardness of coated films when rubbed with coins is quantified by relative evaluations.

[Notes]

Scaly particles; aqueous aluminum paste, trade name “WXM 1440”, manufactured by Toyo Aluminium K.K., median diameter of 30 μm

Aqueous resin emulsion; SBR emulsion, tradename “2853”, Tg of −51° C., manufactured by JSR K.K., solid content of 50%

Aqueous resin emulsion; SBR emulsion, trade name “0602”, Tg of 40° C., manufactured by JSR K.K., solid content of 52%

Aqueous resin emulsion; SBR emulsion, trade name “0589”, Tg of 0° C., manufactured by JSR K.K., solid content of 50%

Next, on the letters printed on card or plain papers by laser printers, each composition for scratching off of Examples and Comparative Examples obtained and showed in the Table 1 or 2 was printed with bar coaters to produce coating films with a thickness of 20 μm, thereby preparing test faces and the evaluation was made as follows. The results are shown in Tables 1 and 2.

Further, the compositions (ink) for scratching off of Examples and Comparative Examples were filled in the trade name “mini stamp for stencil” manufactured by Sakura Color Products Corporation and on the letters printed on card papers by laser printers, the mini stamp was stamped thereby preparing test faces and the evaluation was made as follows. The results are also shown in Tables 1 and 2.

1) Substrate Opacifying Property

Evaluation was based on the following criteria by visual observation.

◯: Letters of substrates could not be made out.

X: Letters of substrates could be made out.

2) Adhesion Property When Rubbed with a Finger

A state of coating films when rubbed with an inner surface of a finger was evaluated by visual observation.

◯: Letters of substrates could not be made out without peel-off of coating films.

X: Letters of substrates could be made out with peel-off of coating films.

3) Adhesion Property When Rubbed with a Coin

A state of coating films when rubbed with a 10-yen coin was evaluated by visual observation.

◯: Coating films could be peeled off

X: Coating films are hard to be peeled off

4) Reading of Letters After Rubbed and Peeled Off was Evaluated by Visual Observation.

◯: Letters of substrates could be made out

X: Letters of substrates are hard to make out 5) Strength of Coating Films

Results were organoleptically evaluated by 10 stages, that is, from 10 (strong) to 1 (weak)

From Table 1, in aqueous color material compositions for scratching off of Examples, since emulsion does not penetrate in paper, coating films have appropriate adhesion property and said films do not fall off even when rubbed with fingers. In addition, in coating films, since resin particles are formed in lump coagulation, they are brittle and when rubbed with hard materials such as coins and the like, coating films are easily peeled off and erased without damaging paper surfaces and after peel-off, letters on substrate can be made out. On the other hand, in Comparative Examples, since resin particles are not formed in lump coagulation, coating films are hard to be peeled off and the letters on substrates are hard to make out.

As shown in Table 2, with Examples in which resins with a glass transition point (Tg) of not greater than −30° C. and resins with a glass transition point (Tg) of not less than 30° C. are mixed, appropriate peel-off property suitable for scratching-off use for card papers and plain papers can be obtained.

Next, using the publicly known methods for producing inks, rubber erasable aqueous color material compositions (aqueous ink compositions) were obtained. To be specific, all the materials stated in Table 3 were put and were stirred with a dissolver for 30 minutes, thereby obtaining aqueous color material compositions in the Examples and Comparative Examples.

TABLE 3
(% by weight)

| | | | | | | | | | | Comparative | |
|---|---|---|---|---|---|---|---|---|---|---|---|
| | | | | Trade | Examples | | | | | Examples | |
| | | | | name | 14 | 15 | 16 | 17 | 18 | 9 | 10 |
| Ink | Aqueous | SBR | 0561 (wt % in | | | | 35.0 | | | | |
| composition | resin | | solids) | | | | (24.2) | | | | |
| | emulsions | | 0561 (wt % in | | 45.0 | 45.0 | | 45.0 | 45.0 | 90.0 | |
| | | | solids) | | (22.5) | (22.5) | | (22.5) | (22.5) | (45.0) | |
| | | Acrylic | POLYZOL | | 45.0 | 45.0 | 45.0 | 45.0 | 45.0 | | 90.0 |
| | | resins | AP-3700 (wt % | | (22.5) | (22.5) | (22.5) | (22.5) | (22.5) | | (45.0) |
| | | | in solids) | | | | | | | | |

| | | | | | | | | |
|---|---|---|---|---|---|---|---|---|
| Colorants | Black pigment dispersions | 2.0 | | | | | 2.0 | |
| | Red pigment dispersions | | 2.0 | | | | | 2.0 |
| | Blue pigment dispersions | | | 2.0 | | | | |
| | Hollow resin particles (in solids) | | | | 3.0 | | | |
| | Flat resin particles (in solids) | | | | | 5.0 | | |

| | Ion exchange water | | | Remnants | Remnants | Remnants | Remnants | Remnants | Remnants | Remnants |
|---|---|---|---|---|---|---|---|---|---|---|
| Evaluation | Adhesion property | ◯ | ◯ | ◯ | ◯ | ◯ | ◯ | ◯ | X | ◯ |
| | when rubbed with | | | | | | | | | |
| | rubber erasers | | | | | | | | | |
| | Adhesion property | ◯ | ◯ | ◯ | ◯ | ◯ | ◯ | ◯ | X | ◯ |
| | when rubbed with | ◯ | | | | | | | | |
| | fingers | | | | | | | | | |
| | Adhesion property | | ◯ | ◯ | ◯ | ◯ | ◯ | ◯ | ◯ | X |
| | when rubbed with | | | | | | | | | |
| | rubbers | | | | | | | | | |
| | State of paper surfaces | ◯ | ◯ | ◯ | ◯ | ◯ | ◯ | ◯ | ◯ | X |
| | Preservation stability | ◯ | ◯ | ◯ | ◯ | ◯ | ◯ | ◯ | ◯ | ◯ |
| | of an ink | | | | | | | | | |

N.B.) In the Table, numerical values in parenthesis in the aqueous resin emulsion section show the weight percentage in solids (resin content).

[Notes]

Aqueous resin emulsion; SBR emulsion, trade name “0561”, Tg of −63° C., manufactured by JSR K.K., solid content of 69%

Aqueous resin emulsion; SBR emulsion, trade name “2853”, Tg of −51° C., manufactured by JSR K.K., solid content of 50%

Aqueous resin emulsion; acrylic emulsion, trade name “POLYZOLAP-3700”, manufactured by SHOWAHIGHPOLYMERCO., LTD., solid content of 50%

Aqueous pigment dispersions;

[Preparation Method]

Aqueous pigment dispersions were prepared by the following content. First, styrene acrylic resins (dispersion resins) were heated and dissolved with sodium hydroxide and ion exchange water, followed by adding ethylene glycol and pigments shown below, further dispersing with a beads-mill, thereby obtaining aqueous pigment dispersions with pigment content of 10% by weight.

| | |
|---|---|
| Pigments | 10% by weight |
| Dispersion resins | 1% by weight |
| Sodium hydroxide | 0.2% by weight |
| Ethylene glycol | 10% by weight |
| Ion exchange water | remnants |

Here, as said styrene acrylic resins (dispersion resins), trade name “JONCRYL 683” (acid value: 160, molecular weight: 8,000) manufactured by Johnson Polymer Co., Ltd. was used.

In addition, regarding said pigments, in the Tables, as black colored pigment dispersions, trade name “PRINTEX G” (carbon black) manufactured by Degussa Japan Co., Ltd. was used, as red colored pigment dispersions, trade name “SHIMURA FAST RED 4127” (azo pigment) manufactured by DAINIPPON INK AND CHEMICALS INCORPORATED was used, and as blue colored pigment dispersions, trade name “FASTGEN BLUE TGR” (phthalocyanine blue pigment) manufactured by DAINIPPON INK AND CHEMICALS INCORPORATED was used.

Hollow resin particles: acryl series resin emulsions (solid content: 30%, average particle diameter: 0.3 μm, manufactured by ROHM AND HASS COMPANY, trade name “ROPAQUE ULTRA”)

Flat resin particles: acryl series resin emulsions (solid content: 50%, average particle diameter: 0.5 μm, manufactured by MITSUI TOATSU CO., LTD., trade name “MUTICLE PP 240D”)

An ink obtained by the above methods was filled in an ink containment tube of an aqueous ball-point pen manufactured by Sakura Color Products Corporation with trade name of “BALLSIGN AQUA LIP”, thereby evaluating written lines. Here, regarding the above ball-point pen, a material of a pipe (tube) is polypropylene, a material of a pen tip is stainless, and a ball diameter is 1 mm.

[Evaluation]

1) Adhesion When Rubbed with a Rubber Eraser

Using trade name “FOAM ERASER W” manufactured by RABBIT Co., Ltd., adhesion when rubbed with a rubber eraser was evaluated based on the following criteria.

◯: Written lines are not peeled off.

X: Written lines are peeled off.

2) Adhesion When Rubbed with a Finger

A state of written lines when rubbed with an inner surface of a finger was evaluated by visual observation based on the following criteria.

◯: Written lines are not peeled off.

X: Written lines are peeled off.

3) Adhesion When Rubbed with a Rubber

A state of written lines when rubbed with a synthetic rubber was evaluated by visual observation based on the following criteria.

◯: Written lines are peeled off.

X: Written lines are not peeled off.

4) State of Paper Surfaces

A state of paper surfaces after erasing written lines was evaluated by visual observation based on the following criteria.

◯: Paper surfaces are not damaged.

X: Paper surfaces are damaged.

5) Evaluation on Preservation Stability

Said ball-point pen was left inverted with a pen-tip downward at a temperature of 50° C. for a week and the pen tip was acknowledged not to be clogged.

As seen from Table 3, ink compositions of the Examples are capable of forming written lines (coating films) which are not erased when rubbed with fingers, and they can be erased with a synthetic rubber without any damage to paper surfaces. In addition, Examples 17 and 18 are excellent in preservation stability.

### INDUSTRIAL APPLICABILITY

The present invention relates to erasable aqueous color material compositions and they can be used as aqueous color material compositions for scratching off or rubber erasable aqueous color material compositions. Further, the present compositions can be used in the form of printing, stamping, writing, coating, and the like. For example, the present compositions can be used as aqueous color material compositions such as printing inks for scratching off or rubber erasing, stamping inks such as mini stamps, inks for writing instruments such as ball-point pens, marking pens, or the like, paints contained in tube containers and the like.

To be more specific, for example, the present compositions are stamps provided with ink containers comprising felt or sponges, and said aqueous color material compositions are included in the abovementioned ink containers. In particular, as stamping inks included in said ink containers, they can be composed of said pigment particles with opacifying property, aqueous emulsions of said resins with lump coagulation property such as styrene butadiene rubbers, carboxy modified styrene butadiene rubbers, or the like, thickening agents, and water can be used.

Further, in addition to the application for stamping inks, erasable aqueous color material compositions of the present invention can preferably be used for inks for writing instruments such as ball-point pens, marking pens, and the like in which pen tips are balls, felts, or the like, and ink containment portions are containment tubes or central cores.

The description of this application claims benefit of priority based on Japan Patent Application Nos. 2004-286413, 2004-286416, 2005-012814, 2005-012822, and 2005-152439, the entire same contents of which are incorporated by reference herein.

What is claimed:

1. Erasable aqueous color material compositions comprising colorants and aqueous emulsions of resins with lump coagulation property.

2. Erasable aqueous color material compositions as set forth in claim 1, comprising aqueous emulsions of resins with a glass transition point (Tg) of not greater than −30° C. as aqueous emulsions of resins with said lump coagulation property.

3. Erasable aqueous color material compositions as set forth in claim 1, comprising aqueous emulsions of resins with a glass transition point (Tg) of not less than drying temperature of coating films as aqueous emulsions of resins with said lump coagulation property.

4. Erasable aqueous color material compositions as set forth in claim 1, comprising aqueous emulsions of resins with a glass transition point (Tg) of not less than 30° C. as aqueous emulsions of resins with said lump coagulation property.

5. Erasable aqueous color material compositions as set forth in claim 1, comprising aqueous emulsions of resins with a glass transition point (Tg) of not greater than −30° C. and aqueous emulsions of resins with a glass transition point (Tg) of not less than 30° C. as aqueous emulsions of resins with said lump coagulation property.

6. Erasable aqueous color material compositions as set forth in claim 1, comprising rubbers selected from the group consisting of styrene butadiene rubbers, acrylonitrile butadiene rubbers, and carboxy modified styrene butadiene rubbers as resins with said lump coagulation property.

7. Erasable aqueous color material compositions as set forth in claim 1, comprising aqueous emulsions of resins with a glass transition point (Tg) of not greater than −30° C. as aqueous emulsions of resins with said lump coagulation property, said reins being rubbers selected from the group of styrene butadiene rubbers, acrylonitrile butadiene rubbers, and carboxy modified styrene butadiene rubbers.

8. Erasable aqueous color material compositions as set forth in claim 1, comprising aqueous emulsions of resins with a glass transition point (Tg) of not less than drying temperature of coating films as aqueous emulsions of resins with said lump coagulation property, said reins being rubbers selected from the group of styrene butadiene rubbers, acrylonitrile butadiene rubbers, and carboxy modified styrene butadiene rubbers.

9. Erasable aqueous color material compositions as set forth in claim 1, comprising aqueous emulsions of resins with a glass transition point (Tg) of not less than 30° C. as aqueous emulsions of resins with said lump coagulation property, said reins being rubbers selected from the group of styrene butadiene rubbers, acrylonitrile butadiene rubbers, and carboxy modified styrene butadiene rubbers.

10. Erasable aqueous color material compositions as set forth in claim 1, comprising aqueous emulsions of resins with a glass transition point (Tg) of not greater than −30° C. and aqueous emulsions of resins with a glass transition point (Tg) of not less than 30° C. as aqueous emulsions of resins with said lump coagulation property, each of said reins being rubbers selected from the group of styrene butadiene rubbers, acrylonitrile butadiene rubbers, and carboxy modified styrene butadiene rubbers.

11. Erasable aqueous color material compositions as set forth in claim 1, wherein said colorants are pigment particles with opacifying property.

12. Erasable aqueous color material compositions as set forth in claim 11, wherein said pigment particles are scaly particles.

13. Erasable aqueous color material compositions as set forth in claim 12, wherein said scaly particles are aluminum particles.

14. Erasable aqueous color material compositions as set forth in claim 11, wherein said pigment particles are synthetic resin particles with a particle diameter of 0.05 to 10 μm.

15. Erasable aqueous color material compositions as set forth in claim 14, wherein said pigment particles are hollow particles or flat particles.

16. Erasable aqueous color material compositions as set forth in claim 11, further comprising colored pigments and/or dyes as colorants.

17. Erasable aqueous color material compositions comprising pigment particles with opacifying property and aqueous emulsions of resins with lump coagulation property, wherein said pigment particles with opacifying property are scaly aluminum particles, said aqueous emulsions of resins with said lump coagulation property are aqueous emulsions of styrene butadiene rubbers or carboxy modified styrene butadiene rubbers, said scaly particles are contained in 1 to 60% by weight with respect to the total amount of the compositions, and said resins with said lump coagulation property are contained in 5 to 40% by weight in solids with respect to the total amount of the compositions.

18. Erasable aqueous color material compositions comprising pigment particles with opacifying property and aqueous emulsions of resins with lump coagulation property, wherein said pigment particles with opacifying property are synthetic resin particles, said aqueous emulsions of resins with said lump coagulation property are aqueous emulsions of styrene butadiene rubbers or carboxy modified styrene butadiene rubbers, said synthetic resin particles are contained in 5 to 35% by weight with respect to the total amount of the compositions, and said resins with said lump coagulation property are contained in 5 to 40% by weight in solids with respect to the total amount of the compositions.

19. Erasable aqueous color material compositions for stamps as set forth in claim 1, further comprising wetting agents.

20. Erasable aqueous color material compositions for stamps comprising pigment particles with opacifying property and aqueous emulsions of resins with lump coagulation property, wherein said pigment particles with opacifying property are scaly aluminum particles, said aqueous emulsions of resins with said lump coagulation property are aqueous emulsions of styrene butadiene rubbers or carboxy modified styrene butadiene rubbers, said wetting agents are agents selected from the group of glycerin, diglycerin, propylene glycol, ethylene glycol, and sorbitol, said compositions further include thixotropic thickening agents selected from polyglycerol mono-fatty acid ester and sorbitan mono-fatty acid ester, said scaly particles are contained in 1 to 60% by weight with respect to the total amount of the compositions, said resins with said lump coagulation property are contained in 5 to 40% by weight in solids with respect to the total amount of the compositions, said wetting agents are contained in not greater than 60% by weight with respect to the total amount of the compositions, said thixotropic thickening agents are contained in not greater than 60% by weight with respect to the total amount of the compositions.

21. Erasable aqueous color material compositions as set forth in claim 1, further comprising aqueous emulsions of acryl series resins.

22. Erasable aqueous color material compositions as set forth in claim 21, comprising colorants, aqueous emulsions of resins with lump coagulation property and aqueous emulsions of acryl series resins, wherein aqueous emulsions of resins with said lump coagulation property are aqueous emulsions of styrene butadiene rubbers, said aqueous emulsions of styrene butadiene rubbers are contained in 5 to 50% by weight in solids, and aqueous emulsions of said acryl series resins are 5 to 50% by weight in solids.

23. Erasable aqueous color material compositions as set forth in claim 21, wherein said colorants include synthetic resin particle pigments as opacifying agents.

24. Erasable aqueous color material compositions as set forth in claim 23, wherein said synthetic resin particle pigments are hollow particles and flat particles.

25. Erasable aqueous color material compositions as set forth in claim 23, wherein said colorants include colored pigments and/or dyes and synthetic resin particle pigments as opacifying agents.

26. Erasable aqueous color material compositions as set forth in claim 21, wherein said colorants are contained in 0.1 to 20% by weight with respect to the total amount of said compositions.

27. Erasable aqueous color material compositions as set forth in claim 11, wherein said erasable aqueous color material compositions are aqueous compositions for scratching off.

28. Erasable aqueous color material compositions as set forth in claim 21, wherein said erasable aqueous color material compositions are erasable aqueous ink compositions.

29. Method of using erasable aqueous color material compositions comprising the steps of; printing on, stamping on, writing on, or coating on erasable aqueous color material compositions comprising pigment particles with opacifying property and aqueous emulsions of resins with powder-coagulation property on absorbing surfaces, thereby opacifying letters and the like of substrates, followed by erasing said opacified coating films by scratching them off, thereby making out letters and the like of the substrates.

30. Method of using erasable aqueous color material compositions comprising the steps of; writing with said erasable aqueous color material compositions comprising colorants, film forming resins, and as said film forming resins, comprising aqueous emulsions of resins with lump coagulation property and aqueous emulsions of acryl series resins thereby forming written lines, followed by erasing by rubbing said written lines not with rubber erasers but with synthetic rubbers.

31. Erasable writing instruments for scratching off wherein erasable aqueous color material compositions comprising pigment particles with opacifying property and aqueous emulsions of resins with lump coagulation property are contained in a containment tube.

32. Erasable writing instruments for erasing synthetic rubbers wherein erasable aqueous color material compositions comprising colorants, film forming resins, and as said film forming resins, comprising aqueous emulsions of resins with lump coagulation property and aqueous emulsions of acryl series resins are contained in a containment tube.
